(19) United States
(12) Patent Application Publication
(10) Pub. No.: US 2026/0048684 A1
(43) Pub. Date: Feb. 19, 2026

(54) SYSTEM AND METHOD TO REDUCE A THERMAL EVENT OF A BATTERY ARRAY

(71) Applicant: Ford Global Technologies, LLC, Dearborn, MI (US)

(72) Inventor: Xiaogang Zhang, Novi, MI (US)

(21) Appl. No.: 18/807,613

(22) Filed: Aug. 16, 2024

(51) Int. Cl. B60L 58/26; H01M 10/48; H01M 10/613; H01M 10/635; H01M 10/6568; H01M 50/249; H01M 50/30

(52) U.S. Cl. CPC B60L 58/26; H01M 10/486; H01M 10/613; H01M 10/635; H01M 10/6568; H01M 50/30; H01M 50/249; H01M 2220/20

(57) ABSTRACT

Systems and methods for reducing a possibility of propagated battery cell degradation are described. In one example, degradation of a battery cell may be determined via pressure or temperature. If degradation is detected, increased cooling of battery cells is held in abeyance to permit venting of gas generated via a battery so that thermal loading and pressures within the battery may be reduced.

### FIELD

The present description relates to methods and a system for a battery. The methods and systems may be particularly useful for batteries that are part of a vehicle and that provide electric charge to propel the vehicle.

### BACKGROUND

A vehicle may include a battery to provide electric charge to an electric machine that propels the vehicle. The battery may be comprised of a plurality of battery cells that are arranged in an array. The array may include battery cells that are electrically coupled in parallel and series. The battery cells may be positioned in close proximity to each other to reduce the size of the battery and to increase efficiency of electric power transfer through the battery. However, the close proximity between adjacent battery cells may increase a possibility of battery degradation if one or more battery cells experience degradation. One way to reduce a possibility of battery degradation may be to disconnect the battery from vehicle power consumers (e.g., the electric machine that propels the vehicle). However, if the battery degradation is internally based, disconnecting the battery from vehicle power consumers may not help to reduce a possibility of additional battery degradation.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle and vehicle charger;

FIG. 2 is a perspective view of an example battery testing configuration;

FIG. 3 shows plots of battery operating conditions during a battery testing procedure;

FIG. 4 shows an example cooling system for a battery;

FIG. 5 shows an example operating sequence for a first battery control strategy;

FIG. 6 shows an example operating sequence for a second battery control strategy;

FIG. 7 shows a flowchart of an example second battery control strategy;

FIG. 8 shows an example operating sequence for a third battery control strategy; and

FIG. 9 shows a flowchart of an example third battery control strategy.

### DETAILED DESCRIPTION

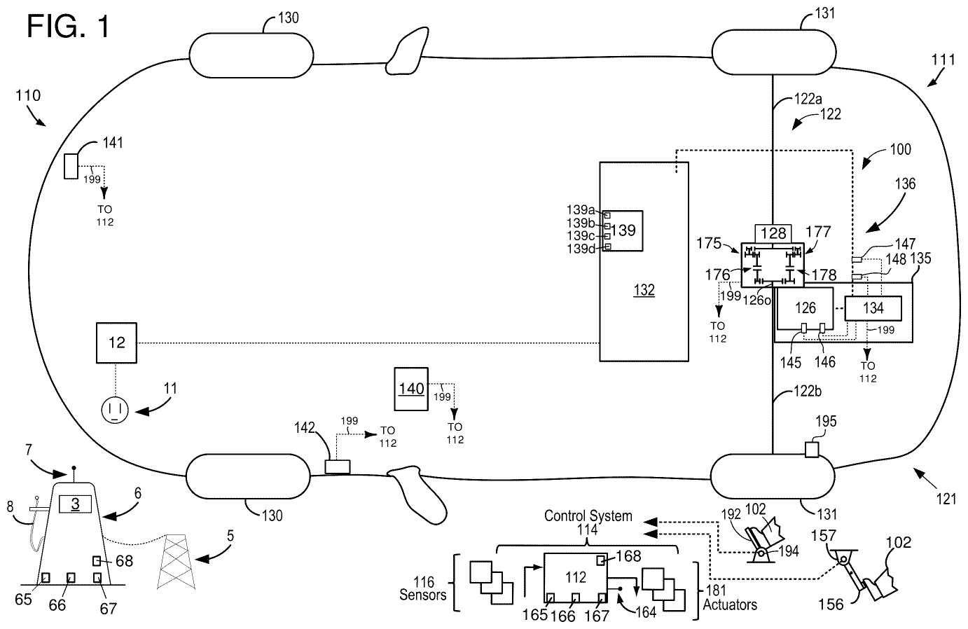

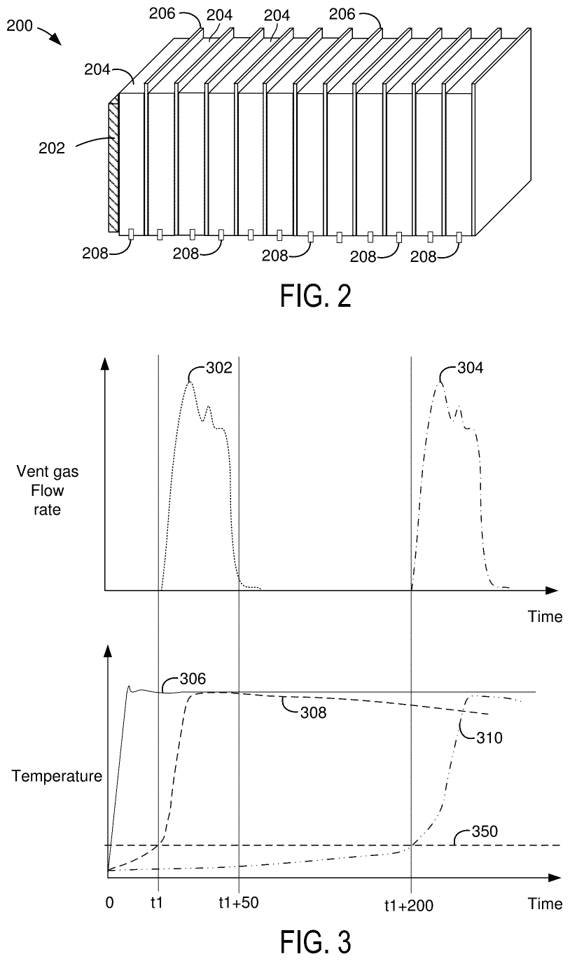

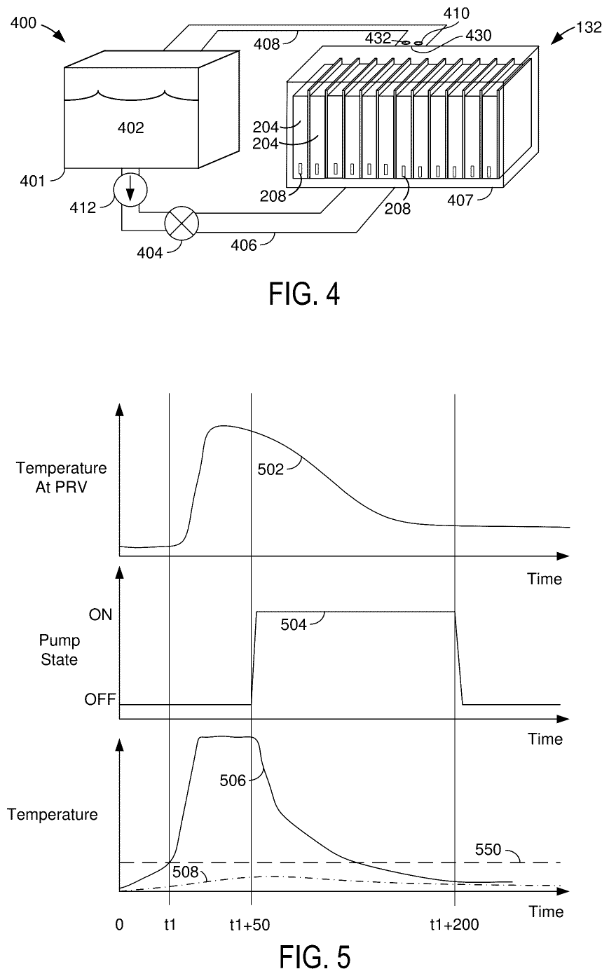

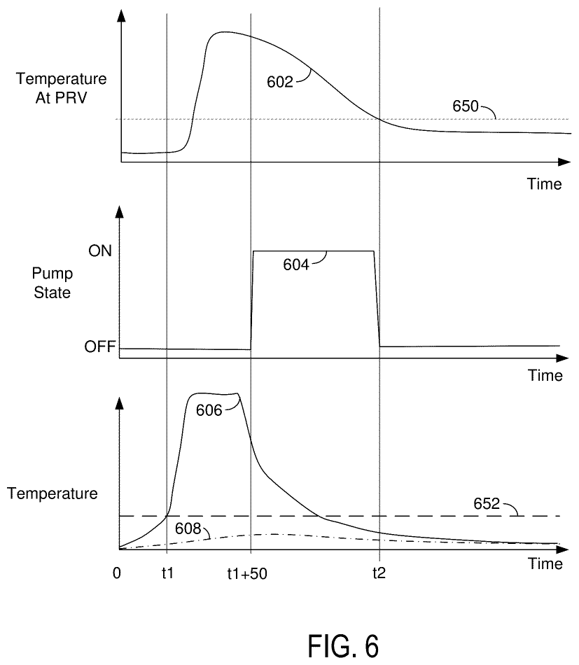

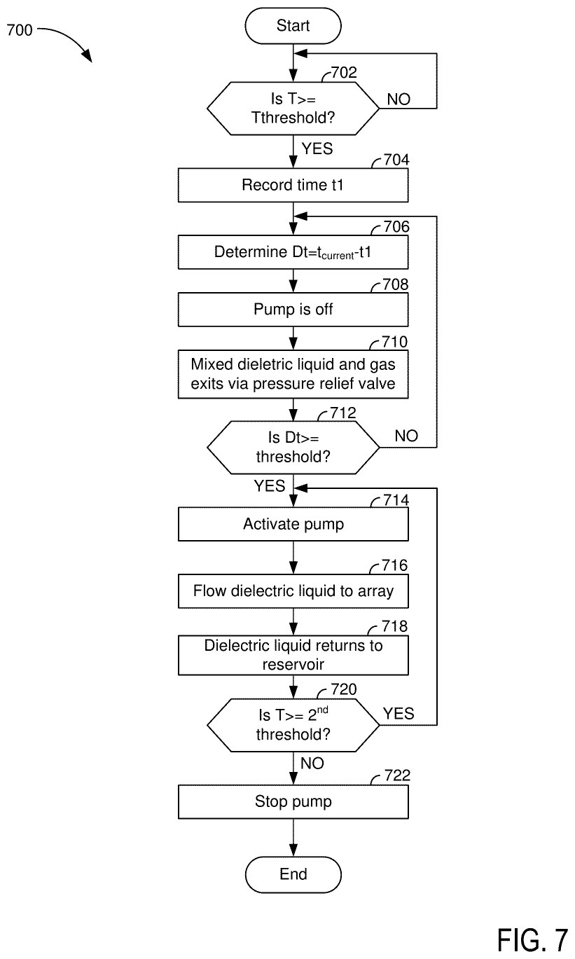

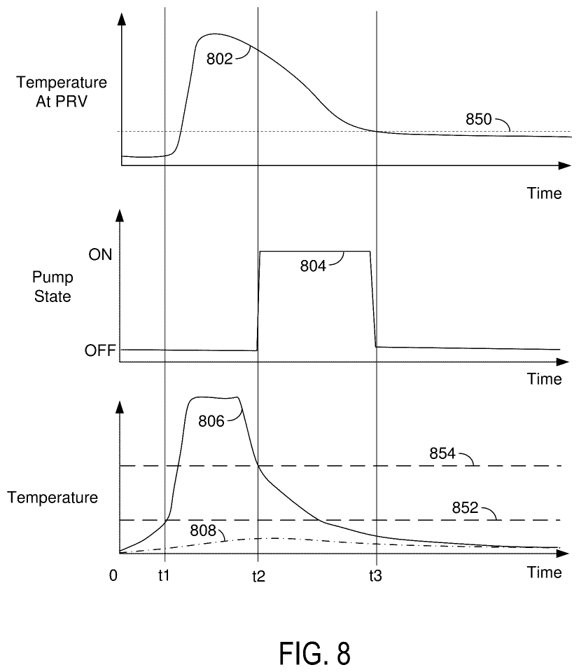

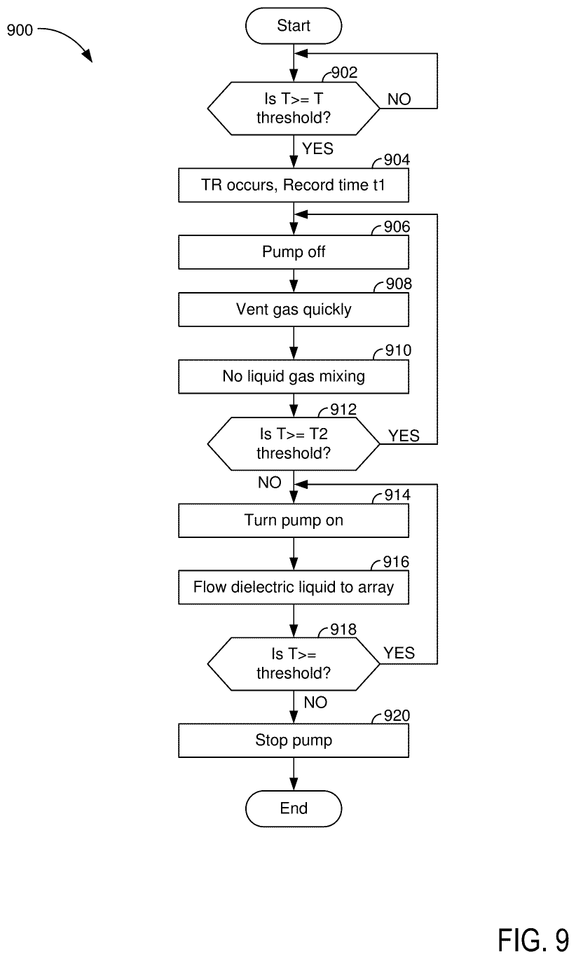

The present description is related to a method and system for controlling temperature and degradation within a battery of a vehicle. In particular, if a temperature of a particular battery cell exceeds a threshold temperature, coolant flow to battery cells may commence after a delay period. By delaying increasing a coolant flow rate to battery cells, it may be possible to let gases from one battery cell vent from the battery enclosure so that there is less tendency for battery gas to mix with battery coolant, thereby reducing pressure within the battery. The gas from a degraded battery cell may be exhausted from the battery enclosure before cooling to the battery is increased so that a greater amount of heat may be released from the battery before heat from the venting battery cell is transferred to battery coolant. Consequently, pressure and temperature within the battery may be reduced so that less heat energy may be transferred to adjacent battery cells. Further, the battery coolant may provide greater cooling capacity for the adjacent battery cells, thereby lowering a possibility of adjacent battery cells degrading. The battery may be included in an electric vehicle as shown in FIG. 1. The battery may be constructed as shown in FIG. 2. The battery may operate as shown in FIG. 3. The battery may be cooled via a cooling system as shown in FIG. 4. The battery may be cooled as shown in FIG. 5. An alternative battery operating sequence is shown in FIG. 6. A flowchart of a method to operate a battery is shown in FIG. 7. A second battery operating sequence is shown in FIG. 8. A second method for operating a battery is shown in FIG. 9.

Unexpected battery temperature increases may be due to battery manufacturing issues, battery cell degradation, and/or deformation of battery cells. For example, a temperature of a battery cell may increase above a threshold temperature in response to degradation of the battery cell. The temperature increase of this degraded battery cell may raise temperatures of adjacent battery cells, thereby resulting in degradation of nearby battery cells. The output capacity of the battery may degrade as battery cells within the battery degrade. Therefore, it may be desirable to provide a way of reducing a possibility of further degradation within a battery when battery cell degradation is detected.

The inventors herein have recognized the above-mentioned issues and have developed a method for a battery, comprising: via a controller, increasing flow of a dielectric liquid to a battery in response to an indication of a battery operating condition exceeding a threshold and a predetermined threshold amount of time passing since a most recent time the indication of the battery operating condition exceeded the threshold.

By delaying introduction of increased dielectric liquid flow to a battery, it may be possible to reduce mixing of battery gases and the dielectric liquid, thereby reducing pressure within the battery and temperature within the battery. This may reduce a possibility of degradation of additional battery cells within a battery. The time delay between detecting battery cell degradation and increasing flow of dielectric fluid may allow a vent valve to open so that gases generated via a degraded battery cell may be purged from the battery. Consequently, a subsequent rise in temperature of other battery cells in the battery may be prevented.

The present description may provide several advantages. In particular, the approach may reduce a possibility of propagation of battery cell degradation when a temperature of a battery cell increases above a threshold temperature. Further, the approach may be based off of pressure or temperature measurements within a battery, thereby increasing the flexibility of the approach. Additionally, the approach may constrain pressure build up within a battery and a water-gas separator may be removed from the battery cooling system, thereby reducing financial expense of the battery cooling system.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a schematic diagram of a vehicle 121 including a powertrain or driveline 100. A front portion of vehicle 121 is indicated at 110 and a rear portion of vehicle 121 is indicated at 111. Driveline 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Driveline 100 has a rear axle 122. In some examples, rear axle 122 may comprise two half shafts, for example first half shaft 122a, and second half shaft 122b. Driveline 100 also includes front wheels 130 and rear wheels 131. Rear wheels 131 may be driven via electric machine 126. The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 1260 of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over network 199. Alternatively, high gear clutch 178 and low gear clutch 176 may be opened and closed via digital outputs or pulse widths provided via control system 114. Rear drive unit 136 may include differential gear set 128 so that torque may be provided to first half shaft 122a and to second half shaft 122b. In some examples, an electrically controlled differential clutch (not shown) may be included in rear drive unit 136.

Electric machine 126 may receive electrical power from onboard electric energy storage device 132. Furthermore, electric machine 126 may provide a generator function to convert the vehicle's kinetic energy into electrical energy, where the electrical energy may be stored at electric energy storage device 132 for later use by electric machine 126. An inverter 134 may convert alternating current generated by electric machine 126 to direct current for storage at the electric energy storage device 132 and vice versa. Electric drive system 135 includes electric machine 126 and inverter 134. Electric energy storage device 132 may be a traction battery (e.g., a battery or traction battery that supplies power to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102 (e.g., a user), or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with vehicle caliper control pedal 156.

Electric energy storage device 132 may periodically receive electric power via power converter 12 and receptacle 11. Receptacle 11 may receive electric power from a vehicle charger 6 and vehicle charger 6 is remote (e.g., external) from vehicle 121. Vehicle charger 6 may wirelessly communicate with vehicle 121 via transceiver 7 and vehicle charger 6 may include an optional HMI 3 (human/machine interface such as a display and/or keyboard). Alternatively, vehicle charger 6 may communicate with vehicle 121 via charging cable 8 (e.g., a wired connection). Vehicle charger 6 may receive electric power from a stationary power grid 5. Vehicle charger 6 includes non-transitory (e.g., read exclusive memory) 65, random access memory 66, digital inputs/outputs 68, and a microcontroller 67. Microcontroller 67 may send and receive messages via transceiver 7. As a non-limiting example, driveline 100 may be configured as a plug-in electric vehicle (EV), whereby electrical energy may be supplied to electric energy storage device 132 via the power grid (not shown). Alternatively, vehicle 121 may be a plug-in hybrid vehicle.

Electric energy storage device 132 (e.g., a battery) includes an electric energy storage device controller 139. Electric energy storage device controller 139 may provide charge balancing between energy storage elements (e.g., battery cells) and communication with other vehicle controllers (e.g., controller 112). The electric energy storage device controller 139 may include a processor 139a, random-access memory 139b, non-transitory read-exclusive memory 139c, and inputs and outputs 139d (e.g., analog and digital inputs and outputs).

One or more wheel speed sensors (WSS) 195 may be coupled to one or more wheels of driveline 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Infotainment system 140 (e.g., a human/machine interface) may receive input data from human 102 and may display messages and data to human 102. Infotainment system 140 may communicate to controller 112 via network 199 (e.g., a controller area network (CAN) or an Ethernet network). Infotainment system 140 and/or controller 112 may also communicate with camera 142 and audible actuator 141 (e.g., a speaker or other sound exciter) via network 199. Although one camera is shown, it may be appreciated that a vehicle may include a plurality of cameras that provide different views of areas that surround vehicle 121. Controller 112 may communicate with vehicle charger 6 via transceiver 164.

Referring now to FIG. 2, a perspective view of an example battery test bed for evaluating battery temperature control is shown. In this example, electric energy storage device 132 (battery) includes an electric heater 202 for simulating an increase in battery temperature due to battery cell degradation, a plurality of battery cell groups 204, and insulators 206 positioned between each of the battery cell groups 204. The battery cell groups 204 may include a plurality of battery cells.

Temperature sensors 208 are shown arranged to sense temperatures at each battery cell group 204. The temperature sensors may supply temperature data to a controller and/or data acquisition system (not shown).

Referring now to FIG. 3, plots of battery operating conditions for the battery illustrated in FIG. 2 are shown. The vertical lines at times t1, t1+50 seconds, and t1+200 seconds represent times of interest during the sequence. Threshold 350 (dashed line) represents a threshold temperature. If a temperature of a battery cell group is above threshold 350, it may be an indication of degradation of a battery cell or battery cell group. The times t0, t1, t1+50 seconds, etc. apply solely to the sequence of FIG. 3 and not to timings of other figures included herein.

The first plot from the top of FIG. 3 is a plot of battery cell vent gas flow rate versus time. The vertical axis represents battery cell vent gas flow rate (e.g., a flow rate of gases vented from a degraded battery cell or cell group) and the battery cell vent gas flow rate increases in the direction of the vertical axis arrow. The horizontal axis represents time and time increases from the left side of the plot to the right side of the plot. Trace 302 (dashed line) represents a temperature of battery cell group one. Battery cell group one is adjacent to and closest to electric heater 202 shown in FIG. 2. Trace 304 (dash-dot line) represents a temperature of battery cell group two. Battery cell group two is adjacent to and closest to battery cell group one.

The second plot from the top of FIG. 3 is a plot of battery cell temperature versus time. The vertical axis represents battery cell temperature and the battery cell temperature increases in the direction of the vertical axis arrow. The horizontal axis represents time and time increases from the left side of the plot to the right side of the plot. Trace 306 (solid line) represents a temperature of heater 202. Trace 308 (dashed line) represents a temperature of battery cell group one. Trace 310 (dash-dot-dot line) represents a temperature of battery cell group two.

At time t0, the electric heater is activated and its temperature begins to increase. The vent gas flow rate of battery cell group one is zero and the vent gas flow rate of battery cell group two is zero. The temperature of battery group one begins to increase slowly. The temperature of battery group two is at a low level.

At time t1, the electric heater remains activated and its temperature has stabilized at a higher level. The temperature of battery cell group one exceeds threshold 350 and so the vent gas flow rate of battery cell group one begins to increase shortly thereafter at a relatively high rate. The vent gas flow rate for battery cell group two remains unchanged. The temperature of battery group two is at a low level.

Between time t1 and time t1+50 seconds, the electric heater remains activated and its temperature has stabilized at the higher level. The temperature of battery cell group one remains above threshold 350 and the vent gas flow rate of battery cell group rises to a higher level and then it begins to decrease as gas exits the battery cell group one and enters the battery enclosure. The vent gas flow rate for battery cell group two remains unchanged. The temperature of battery group two remains at a low level. Gas in the battery enclosure may be vented as pressure in the battery enclosure begins to increase due to venting of battery cell group one.

At time t1+50 seconds, the electric heater remains activated and its temperature has stabilized at the higher level. The temperature of battery cell group one remains above threshold 350 and the vent gas flow rate of battery cell group one has been reduced to near zero. The vent gas flow rate for battery cell group two remains low. The temperature of battery group two is at a low level.

The inventor herein has recognized that between time t1+50 seconds and time t1+200 seconds offers an opportunity to increase cooling of the battery cell groups before the next adjacent battery cell group exceeds threshold 350. Increasing cooling of battery cells in this time window may allow the battery cells to cool with less mixing of battery gas with dielectric liquid. Consequently, peak pressure in the battery may be lowered and lower thermal stress may be applied to battery cooling system components. Further, the heat transfer between battery cell groups may be quenched sooner and may make it easier to cool other battery cell groups.

At time t1+200 seconds, the electric heater remains activated and its temperature remains stabilized at the higher level. The temperature of battery cell group one remains above threshold 350 and the vent gas flow rate of battery cell group one has been reduced to near zero. The temperature of battery group two exceeds threshold 350 and temperature in battery cell group two begins to increase shortly thereafter because extra coolant is not flowed to the battery.

Referring now to FIG. 4, a perspective view of an example battery cooling system is shown. Battery cooling system 400 includes a reservoir 401 for storing dielectric liquid 402 (coolant). A conduit or pipe 406 extends between reservoir 401 and battery enclosure 407. Pump 412 and valve 404 may be selectively activated via controller 139 of FIG. 1. Pump 412 and valve 404 are shown positioned along conduit or pipe 406. A return conduit 408 also provides fluid communication between reservoir 401 and battery enclosure 407. A temperature sensor 410 is shown at enclosure outlet 430 near a pressure relief valve 432. Temperature sensors 208 are shown arranged to sense temperatures at each battery cell group 204. The temperature sensors may supply temperature data to controller 139 of FIG. 1. In alternative examples, pressure sensors may be provided at the locations that temperature sensors are shown in FIG. 4.

In response to a battery cell group temperature exceeding a threshold temperature, pump 412 may be activated and/or its rotational speed may be increased. Further, valve 404 may be opened further to cool battery cell groups 204 according to the methods of FIGS. 7 and 9.

Thus, the system of FIGS. 1 and 4 provides for a battery operating system, comprising: one or more battery cells; a pump and a reservoir; a dielectric fluid; and a controller including executable instructions stored in non-transitory memory that cause the controller to enter a battery temperature control mode in response to a battery operating condition exceeding a first threshold, increasing output of a pump in response to the battery operating condition being less than a second threshold, and reducing output of the pump in response to the battery operating condition being less than a third threshold. In a first example, the battery operating system includes where the battery operating condition is a battery temperature. In a second example that may include the first example, the battery operating system includes where the battery operating condition is a battery pressure. In a third example that may include one or both of the first and second examples, the battery operating system further comprises additional executable instructions that cause the controller to open a valve in response to the battery operating condition being less than the second threshold. In a fourth example that may include one or more of the first through third examples, the battery operating system further comprises additional executable instructions that cause the controller to close the valve in response to the battery operating condition being less than the third threshold. In a fifth example that may include one or more of the first through fourth examples, the battery operating system further comprises a vent valve. In a sixth example that may include one or more of the first through fifth examples, the battery operating system includes where the second threshold is indicative of gases being vented from a battery enclosure via the vent valve. In a seventh example that may include one or more of the first through sixth examples, the battery operating system includes where the vent valve is positioned at an outlet of the battery enclosure.

Turning now to FIG. 5, an example control sequence for cooling of a traction battery is shown. The sequence of FIG. 5 may be applied to the system of FIGS. 1 and 4. FIG. 5 includes three plots and vertical lines that show times of interest. The times t0, t1, t1+50 seconds, etc. apply solely to the sequence of FIG. 5 and not to timings of other figures included herein.

The first plot from the top of FIG. 5 is a plot of a temperature at an exit or outlet of a battery enclosure versus time. Trace 502 represents a temperature at the outlet of the battery enclosure (e.g., a temperature measured via sensor 410). The vertical axis represents temperature and temperature increases in the direction of the vertical axis arrow. The horizontal axis represents time and time increases from the left side of the figure to the right side of the figure.

The second plot from the top of FIG. 5 is a plot of pump operating state versus time. Trace 504 represents a pump operating state for a pump (e.g., 412 of FIG. 4) that may supply dielectric liquid to a battery enclosure. The vertical axis represents pump operating state and the pump is activated and rotating when trace 504 is at a higher level near the vertical axis arrow. The pump is deactivated when trace 504 is near the horizontal axis. The horizontal axis represents time and time increases from the left side of the figure to the right side of the figure.

The third plot from the top of FIG. 5 is a plot of a battery cell group temperature versus time. Trace 506 represents a temperature at the battery cell group that experiences degradation. Trace 508 represents a temperature at the battery cell group that is next to or adjacent to the battery cell group that is experiencing degradation. The vertical axis represents battery cell group temperature and battery cell group temperature increases in the direction of the vertical axis arrow. The horizontal axis represents time and time increases from the left side of the figure to the right side of the figure. Threshold 550 (dashed line) represents a threshold temperature that may be indicative of battery cell group degradation when battery cell temperature is greater than the value of threshold 550.

At time to, the temperature at the exit of the battery enclosure is low and the dielectric coolant pump is off. The temperature of battery cell group that experiences degradation is low and the temperature of the battery cell group that is adjacent to the battery cell group that experiences degradation is low. Shortly after time t0, the temperature of the battery that experiences degradation begins to increase.

At time t1, the temperature at the exit of the battery enclosure remains low and the dielectric coolant pump is off. The temperature of battery cell group that experiences degradation now exceeds threshold 550 to indicate that the battery cell group is experiencing degradation (e.g., reduced performance, storage capacity, sourcing capacity, etc.) and the temperature of the battery cell group that is adjacent to the battery cell group that experiences degradation is low.

Between time t1 and time t1+50 seconds, temperature within the battery enclosure increases and the pressure valve that controls pressure within the battery enclosure opens to vent the battery enclosure of gases (not shown). The temperature at the exit of the battery enclosure increases and then it levels off at a relatively high level before it begins to decrease. The dielectric coolant pump is off so that mixing of coolant and gases may be reduced, thereby reducing pressure and temperature within the battery enclosure. The temperature of battery cell group that experiences degradation reaches a higher level and the levels off. The temperature of the battery cell group that is adjacent to the battery cell group that experiences degradation increases slowly.

At time t1+50 seconds (e.g., time t1 plus 50 seconds), temperature within the battery enclosure is gradually decreasing and the dielectric coolant pump is activated to cool the battery cell groups. The temperature of battery cell group that experiences degradation remains at the higher level. The temperature of the battery cell group that is adjacent to the battery cell group that experiences degradation continues to increase slowly.

At time t1+200 seconds (e.g., time t1+200 seconds), temperature within the battery enclosure has decreased to a lower level so the dielectric coolant pump is deactivated. The temperature of battery cell group that experiences degradation has decreased below threshold 550. The temperature of the battery cell group that is adjacent to the battery cell group that experiences degradation does not exceed threshold 550, thereby preventing propagation of degradation of the adjacent battery cell group.

Thus, by delaying introduction of dielectric coolant to a group of battery cell groups, it may be possible to reduce degradation of additional battery cell groups. The delay allows the gases that are generated as temperature rises in a battery cell group that is degrading to be vented from the battery enclosure. This reduces mixing of gases and coolant in the battery, thereby reducing pressure within the battery. As a result, the dielectric coolant may more effectively cool battery cell groups since it transfers less heat from released gases. Further, pressure within the battery enclosure may be reduced as compared to if coolant is delivered to the battery pack immediately in response to a temperature of a battery cell group exceeding a threshold temperature. This may reduce a possibility of deformation of the battery enclosure and help to reduce temperature within the battery enclosure.

It may be appreciated that while the description of FIG. 5 describes a control strategy that is based on temperature, similar performance may be achieved by responding to pressures within battery cell groups and within the battery enclosure instead of temperature. For example, pressure within the battery enclosure may be substituted for pressure in the first plot from the top of FIG. 5 and battery cell group pressure may be substituted for battery cell temperature in the third plot from the top of FIG. 5. Additionally, it may be appreciated that the times t1+50 seconds and t1+200 seconds may be other than t1 plus 50 seconds and t1 plus 200 seconds for different batteries. For example, actions taken at time t1 plus 50 seconds may be taken at time t1 plus 45 or 55 seconds.

Turning now to FIG. 6, an example control sequence for cooling of a traction battery according to the method of FIG. 7 is shown. The sequence of FIG. 6 may be applied to the system of FIGS. 1 and 4. FIG. 6 includes three plots and vertical lines that show times of interest. The times t0, t1, t1+50 seconds, etc. apply solely to the sequence of FIG. 6 and not to timings of other figures included herein.

The first plot from the top of FIG. 6 is a plot of a temperature at an exit or outlet of a battery enclosure versus time. Trace 602 represents a temperature at the outlet of the battery enclosure (e.g., a temperature measured via sensor 410). The vertical axis represents temperature and temperature increases in the direction of the vertical axis arrow. The horizontal axis represents time and time increases from the left side of the figure to the right side of the figure. Threshold 650 (dashed line) represents a threshold temperature below which the dielectric pump is deactivated after the pump was most recently activated.

The second plot from the top of FIG. 6 is a plot of pump operating state versus time. Trace 604 represents a pump operating state for a pump (e.g., 412 of FIG. 4) that may supply dielectric liquid to a battery enclosure. The vertical axis represents pump operating state and the pump is activated and rotating when trace 604 is at a higher level near the vertical axis arrow. The pump is deactivated when trace 604 is near the horizontal axis. The horizontal axis represents time and time increases from the left side of the figure to the right side of the figure.

The third plot from the top of FIG. 6 is a plot of a battery cell group temperature versus time. Trace 606 represents a temperature at the battery cell group that experiences degradation. Trace 608 represents a temperature at the battery cell group that is next to or adjacent to the battery cell group that is experiencing degradation. The vertical axis represents battery cell group temperature and battery cell group temperature increases in the direction of the vertical axis arrow. The horizontal axis represents time and time increases from the left side of the figure to the right side of the figure. Threshold 652 (dashed line) represents a threshold temperature that may be indicative of battery cell group degradation when battery cell temperature is greater than the value of threshold 652.

At time t0, the temperature at the exit of the battery enclosure is low and the dielectric coolant pump is off. The temperature of battery cell group that experiences degradation is low and the temperature of the battery cell group that is adjacent to the battery cell group that experiences degradation is low. Shortly after time to, the temperature of the battery that experiences degradation begins to increase.

At time t1, the temperature at the exit of the battery enclosure remains low and the dielectric coolant pump is off. The temperature of battery cell group that experiences degradation now exceeds threshold 652 to indicate that the battery cell group is experiencing degradation (e.g., reduced performance, storage capacity, sourcing capacity, etc.) and the temperature of the battery cell group that is adjacent to the battery cell group that experiences degradation is low.

Between time t1 and time t1+50 seconds, temperature within the battery enclosure increases and the pressure valve that controls pressure within the battery enclosure opens to vent the battery enclosure of gases (not shown). The temperature at the exit of the battery enclosure increases and then it levels off at a relatively high level before it begins to decrease. The dielectric coolant pump is off so that mixing of coolant and gases may be reduced, thereby reducing pressure and temperature within the battery enclosure. The temperature of battery cell group that experiences degradation reaches a higher level and the levels off. The temperature of the battery cell group that is adjacent to the battery cell group that experiences degradation increases slowly.

At time t1+50 seconds, temperature within the battery enclosure is gradually decreasing and the dielectric coolant pump is activated to cool the battery cell groups. The temperature of battery cell group that experiences degradation is also decreasing. The temperature of the battery cell group that is adjacent to the battery cell group that experiences degradation continues to increase slowly.

At time t2, temperature within the battery enclosure has decreased to less than the second threshold 650 so the dielectric coolant pump is deactivated. The temperature of battery cell group that experiences degradation has decreased below threshold 652. The temperature of the battery cell group that is adjacent to the battery cell group that experiences degradation does not exceed threshold 652, thereby preventing propagation of degradation of the adjacent battery cell group.

Thus, similar to the sequence of FIG. 5, delaying introduction of dielectric coolant to a group of battery cell groups may make it possible to reduce degradation of additional battery cell groups. However, in this example, the pump remains activated until a temperature at the exit of the battery is less than a threshold temperature, which provides verification that increasing thermal conditions may indeed be suppressed. Additionally, the sequence of FIG. 5 may conserve pumping of dielectric fluid through the battery because this approach does not deactivate the pump solely based on time since most recently exceeding a threshold temperature.

Referring now to FIG. 7, a method for controlling a traction battery is shown. The method of FIG. 7 may be incorporated into the system of FIGS. 1 and 4 as executable instructions stored in non-transitory memory of a controller. The method of FIG. 7 may generate the sequence of FIG. 6. The method of FIG. 7 may cooperate with the system of FIGS. 1 and 4 to cause a controller to monitor sensors and adjust actuators in the real-world. Method 7 may be executed when dielectric liquid is not surrounding the array of battery cell groups or when there is dielectric liquid that is surrounding the array of battery cell groups.

At 702, method 700 judges whether or not a temperature of a battery cell group or battery cell (T) is greater than a predetermined threshold temperature (T_{threshold}). If so, the answer is yes and method 700 proceeds to 704. Otherwise, the answer is no and method 700 returns to 702 or alternatively exits. A temperature of a battery cell or battery cell group exceeding a threshold temperature may be indicative of battery cell group or battery cell degradation.

At 704, method 700 records a present time (e.g., the time that the temperature of the battery cell group exceeded the threshold temperature) as time t1. Method 700 proceeds to 706.

At 706, method 700 determines an amount of time that has lapsed since a temperature of a battery cell group most recently exceeded a threshold temperature. To make this determination, method 700 subtracts the time t1 from a present time (e.g., t_{current}). The result is stored under a variable named Dt. Method 700 proceeds to 708.

At 708, the pump (e.g., 412 of FIG. 4) is off and not rotating. Further, the cooling valve (e.g., 404 of FIG. 4) may be closed. Method 700 proceeds to 710.

At 710, method 700 expels a mixture of gas generated via a battery cell group and dielectric liquid via a pressure relief valve of the battery if dielectric liquid is surrounding the array of battery cell groups. If dielectric liquid is not surrounding the array of battery cell groups, the pressure relief valve may release gases from a battery enclosure. The pressure relief valve may control pressure in the battery enclosure without assistance of a controller. Method 700 proceeds to 712.

At 712, method 700 judges whether or not the value of Dt is greater than a predetermined threshold amount of time. If so, the answer is yes and method 700 proceeds to 714. Otherwise, the answer is no and method 700 returns to 706. In one example, the predetermined amount of time may be empirically determined via inducing degradation of one or more battery cell groups of a battery and determining an amount of time it takes for a temperature of a degraded battery cell group to begin declining after it started to increase due to thermal degradation of the battery cell group, for example. In some examples, the predetermined amount of time may vary as a function of battery cell group state of charge varies. For example, the threshold temperature may be a first value for a first battery state of charge and a second value for a second battery state of charge, where the first value is less than the second value and the first battery state of charge is less than the second battery state of charge. Additionally, the predetermined threshold amount of time may also be based on charge storage capacity of battery cell groups and/or other battery cell group attributes.

At 714, method 700 activates the dielectric pump (e.g., 412 of FIG. 4). The pump may be activated via the battery controller. If the dielectric pump is already activated, its rotational speed may be increased. Method 700 proceeds to 716.

At 716, method 700 begins increasing dielectric liquid flow to the battery enclosure and around the array of battery cell groups. In one example, increasing dielectric liquid flow to the battery enclosure includes opening or opening further a valve (e.g., valve 404). Method 700 proceeds to 718.

At 718, method 700 includes returning the dielectric liquid to a reservoir so that the dielectric liquid exits via a return conduit (e.g., 408 of FIG. 4). Method 700 proceeds to 718.

At 720, method 700 judges whether or not the temperature of the battery cell group is greater than a second threshold temperature (e.g., 650 of FIG. 6) after the temperature of the battery cell group has exceeded the second threshold temperature following the battery cell group temperature exceeding the first threshold temperature. If not, the answer is no and method 700 proceeds to 722. Otherwise, the answer is yes and method 700 returns to 714.

At 722, method 700 stops rotation of the dielectric liquid pump. Additionally, method 700 may close or reduce an opening amount of a valve in the battery cooling system. This conserves electric power and readies the pump for other increases in battery temperature that may occur at a later time. Method 700 proceeds to exit.

In this way, method 700 may allow gas or gas and liquid to be purged from a battery enclosure before increasing dielectric liquid flow to cells of the battery. The pump may be activated based on a time since degradation of the battery is indicated by a temperature of the battery exceeding a first threshold temperature. The pump may be deactivated after a temperature of a battery cell group falls below a second threshold temperature after the battery cell group temperature exceeded the first threshold temperature and the second threshold temperature.

Referring now to FIG. 8, an example control sequence for cooling of a traction battery according to the method of FIG. 9 is shown. The sequence of FIG. 8 may be applied to the system of FIGS. 1 and 4. FIG. 8 includes three plots and vertical lines that show times of interest. The times t0, t1, t2, and t3 apply solely to the sequence of FIG. 8 and not to timings of other figures included herein.

The first plot from the top of FIG. 8 is a plot of a temperature at an exit or outlet of a battery enclosure versus time. Trace 802 represents a temperature at the outlet of the battery enclosure (e.g., a temperature measured via sensor 410). The vertical axis represents temperature and temperature increases in the direction of the vertical axis arrow. The horizontal axis represents time and time increases from the left side of the figure to the right side of the figure. Threshold 850 (dashed line) represents a threshold temperature below which the dielectric pump is deactivated after the pump was most recently activated.

The second plot from the top of FIG. 8 is a plot of pump operating state versus time. Trace 804 represents a pump operating state for a pump (e.g., 412 of FIG. 4) that may supply dielectric liquid to a battery enclosure. The vertical axis represents pump operating state and the pump is activated and rotating when trace 804 is at a higher level near the vertical axis arrow. The pump is deactivated when trace 804 is near the horizontal axis. The horizontal axis represents time and time increases from the left side of the figure to the right side of the figure.

The third plot from the top of FIG. 8 is a plot of a battery cell group temperature versus time. Trace 806 represents a temperature at the battery cell group that experiences degradation. Trace 808 represents a temperature at the battery cell group that is next to or adjacent to the battery cell group that is experiencing degradation. The vertical axis represents battery cell group temperature and battery cell group temperature increases in the direction of the vertical axis arrow. The horizontal axis represents time and time increases from the left side of the figure to the right side of the figure. Threshold 852 (dashed line) represents a threshold temperature that may be indicative of battery cell group degradation when battery cell temperature is greater than the value of threshold 852. Threshold 854 (dashed line) represents a second threshold temperature that may be indicative of the battery cell group that is experiencing degradation being depleted of a substantial amount of its heat generating compounds.

At time t0, the temperature at the exit of the battery enclosure is low and the dielectric coolant pump is off. The temperature of battery cell group that experiences degradation is low and the temperature of the battery cell group that is adjacent to the battery cell group that experiences degradation is low. Shortly after time t0, the temperature of the battery that experiences degradation begins to increase.

At time t1, the temperature at the exit of the battery enclosure remains low and the dielectric coolant pump is off. The temperature of battery cell group that experiences degradation now exceeds threshold 852 to indicate that the battery cell group is experiencing degradation (e.g., reduced performance, storage capacity, sourcing capacity, etc.) and the temperature of the battery cell group that is adjacent to the battery cell group that experiences degradation is low.

Between time t1 and time t2, temperature within the battery enclosure increases and the pressure relief valve that controls pressure within the battery enclosure opens to vent the battery enclosure of gases (not shown). The temperature at the exit of the battery enclosure increases and then it levels off at a relatively high level before it begins to decrease. The dielectric coolant pump is off so that mixing of coolant and gases may be reduced, thereby reducing pressure and temperature within the battery enclosure. The temperature of battery cell group that experiences degradation reaches a higher level and the levels off. The temperature of the battery cell group that is adjacent to the battery cell group that experiences degradation increases slowly.

At time t2, temperature within the battery enclosure is gradually decreasing. The dielectric coolant pump is activated in response to the temperature of the battery cell group that is experiencing degradation falling below the threshold 854 (e.g., the second threshold temperature) after it had increased above the first and second threshold temperatures.

At time t3, temperature within the battery enclosure has decreased to less than threshold 850 (e.g., a temperature threshold) so the dielectric coolant pump is deactivated. The temperature of battery cell group that experiences degradation has decreased below threshold 850. The temperature of the battery cell group that is adjacent to the battery cell group that experiences degradation does not exceed threshold 852. This prevents propagation of degradation of the adjacent battery cell group.

Thus, similar to the sequence of FIG. 6, delaying introduction of dielectric coolant to a group of battery cell groups may make it possible to reduce degradation of additional battery cell groups. However, in this example, the pump is activated in response to the temperature of the battery cell group that is experiencing degradation declining below threshold 854. This may allow the pump to operate for a shorter time duration, thereby conserving electric power and cooling capacity of the dielectric liquid.

Referring now to FIG. 9, a method for controlling a traction battery is shown. The method of FIG. 9 may be incorporated into the system of FIGS. 1 and 4 as executable instructions stored in non-transitory memory of a controller. The method of FIG. 9 may generate the sequence of FIG. 8. The method of FIG. 9 may cooperate with the system of FIGS. 1 and 4 to cause a controller to monitor sensors and adjust actuators in the real-world. Method 9 may be executed when dielectric liquid is not surrounding the array of battery cell groups or when there is dielectric liquid that is surrounding the array of battery cell groups.

At 902, method 900 judges whether or not a temperature of a battery cell group or battery cell (T) is greater than a predetermined threshold temperature (Tthreshold, for example 852 of FIG. 8). If so, the answer is yes and method 900 proceeds to 904. Otherwise, the answer is no and method 900 returns to 902 or alternatively exits. A temperature of a battery cell or battery cell group exceeding a threshold temperature may be indicative of battery cell group or battery cell degradation.

At 904, method 900 records a present time (e.g., the time that the temperature of the battery cell group exceeded the threshold temperature) as time t1. Method 900 proceeds to 906.

At 906, the pump (e.g., 412 of FIG. 4) is off and not rotating. Further, the cooling valve (e.g., 404 of FIG. 4) may be closed. Method 900 proceeds to 908.

At 908, method 900 expels a mixture of gas generated via a battery cell group and dielectric liquid via a pressure relief valve of the battery if dielectric liquid is surrounding the array of battery cell groups. If dielectric liquid is not surrounding the array of battery cell groups, the pressure relief valve may release gases from a battery enclosure. The pressure relief valve may control pressure in the battery enclosure without assistance of a controller. Method 900 proceeds to 910.

At 910, method 900 mixing of gases with dielectric liquid is constrained by preventing increasing flow of dielectric liquid to the array of battery cell groups. In one example, mixing of gases and dielectric liquid may be constrained by closing or maintaining a position of a valve (e.g., 404). Method 900 proceeds to 912.

At 912, method 900 judges whether or not a temperature of the battery cell group is greater than a second threshold temperature (e.g., 854 of FIG. 8) after the temperature of the battery cell group most recently exceeded the first temperature threshold and the second temperature threshold. If so, the answer is yes and method 900 returns to 906. If not, the answer is no and method 900 proceeds to 914.

At 914, method 900 activates the dielectric pump (e.g., 412 of FIG. 4). The pump may be activated via the battery controller. If the dielectric pump is already activated, its rotational speed may be increased. Method 900 proceeds to 916.

At 916, method 900 begins increasing dielectric liquid flow to the battery enclosure and around the array of battery cell groups. In one example, increasing dielectric liquid flow to the battery enclosure includes opening or opening further a valve (e.g., valve 404). Method 900 proceeds to 918.

At 918, method 900 judges whether or not the temperature at the exit of the battery enclosure is less than or equal to a threshold temperature (e.g., 850 of FIG. 8). If so, the answer is yes and method 900 returns to 914. If not, the answer is no and method 900 proceeds to 920.

At 920, method 900 stops rotation of the dielectric liquid pump. Additionally, method 900 may close or reduce an opening amount of a valve in the battery cooling system. This conserves electric power and readies the pump for other increases in battery temperature that may occur at a later time. Method 700 proceeds to exit.

In this way, method 700 may allow gas or gas and liquid to be purged from a battery enclosure before increasing dielectric liquid flow to cells of the battery. The pump may be activated based on a pressure reduction that follows an increase in pressure at a battery cell group.

The methods of FIGS. 7 and 9 provide for a method for a battery, comprising: via a controller, increasing flow of a dielectric liquid to a battery in response to an indication of a battery operating condition exceeding a threshold and a predetermined threshold amount of time passing since a most recent time the indication of the battery operating condition exceeded the threshold. In a first example, the method includes where the threshold is a temperature that varies with a state of charge of the battery. In a second example that may include the first example, the method includes where the battery operating condition is a battery temperature. In a third example that may include one or both of the first and second examples, the method includes where the battery temperature is indicated via a temperature sensor at a dielectric liquid exit of the battery. In a fourth example that may include one or more of the first through third examples, the method includes where the battery operating condition is a battery pressure. In a fifth example that may include one or more of the first through fourth examples, the method includes where the dielectric liquid flow is increased via increasing a speed of a pump or opening a valve. In a sixth example that may include one or more of the first through fifth examples, the method further comprises reducing dielectric liquid flow in response to a second predetermined threshold amount of time passing since the most recent time the indication of the battery operating condition exceeded the threshold.

The methods of FIGS. 7 and 9 also provide for a method for a battery, comprising: detecting degradation of a battery cell and purging at least a portion of gas generated via the battery cell via a pressure relief valve; and via a controller, increasing flow of a dielectric liquid to a battery in response to an indication that at least the portion of gas generated via the battery cell has been purged from the battery. In a first example, the method includes detecting degradation of the battery cell is based on a battery temperature or pressure. In a second example that may include the first example, the method includes where the indication that at least the portion of gas generated via the battery cell has been purged is based on an amount of time since detecting degradation of the battery cell. In a third example that may include one or both of the first and second examples, the method includes where the indication that at least the portion of gas generated via the battery cell has been purged is based on a pressure in the battery falling below a threshold pressure. In a fourth example that may include one or more of the first through fourth examples, the further comprises decreasing flow of the dielectric liquid to the battery in response to a temperature of the battery.

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, electric and hybrid vehicle configurations could use the present description to advantage.

1. A method for a battery, comprising:
via a controller, increasing flow of a dielectric liquid to the battery in response to an indication of a battery operating condition exceeding a threshold and a predetermined threshold amount of time passing since a most recent time the indication of the battery operating condition exceeded the threshold.

2. The method for the battery of claim 1, where the threshold is a temperature that varies with a state of charge of the battery.

3. The method for the battery of claim 1, where the battery operating condition is a battery temperature.

4. The method for the battery of claim 3, where the battery temperature is indicated via a temperature sensor at a dielectric liquid exit of the battery.

5. The method for the battery of claim 1, where the battery operating condition is a battery pressure.

6. The method for the battery of claim 1, where flow of the dielectric liquid is increased via increasing a speed of a pump or opening a valve.

7. The method for the battery of claim 1, further comprising reducing dielectric liquid flow in response to a second predetermined threshold amount of time passing since the most recent time the indication of the battery operating condition exceeded the threshold.

8. A battery operating system, comprising:
one or more battery cells;
a pump and a reservoir;
a dielectric fluid; and
a controller including executable instructions stored in non-transitory memory that cause the controller to enter a battery temperature control mode in response to a battery operating condition exceeding a first threshold, increasing output of the pump in response to the battery operating condition being less than a second threshold, and reducing output of the pump in response to the battery operating condition being less than a third threshold.

9. The battery operating system of claim 8, where the battery operating condition is a battery temperature.

10. The battery operating system of claim 8, where the battery operating condition is a battery pressure.

11. The battery operating system of claim 8, further comprising additional executable instructions that cause the controller to open a valve in response to the battery operating condition being less than the second threshold.

12. The battery operating system of claim 11, further comprising additional executable instructions that cause the controller to close the valve in response to the battery operating condition being less than the third threshold.

13. The battery operating system of claim 8, further comprising a vent valve.

14. The battery operating system of claim 13, where the second threshold is indicative of gases being vented from a battery enclosure via the vent valve.

15. The battery operating system of claim 14, where the vent valve is positioned at an outlet of the battery enclosure.

16. A method for a battery, comprising:
detecting degradation of a battery cell and purging at least a portion of gas generated via the battery cell via a pressure relief valve; and
via a controller, increasing flow of a dielectric liquid to the battery in response to an indication that at least the portion of gas generated via the battery cell has been purged from the battery.

17. The method of claim 16, detecting degradation of the battery cell is based on a battery temperature or a pressure.

18. The method of claim 17, where the indication that at least the portion of gas generated via the battery cell has been purged is based on an amount of time since detecting degradation of the battery cell.

19. The method of claim 17, where the indication that at least the portion of gas generated via the battery cell has been purged is based on the pressure falling below a threshold pressure.

20. The method of claim 16, further comprising decreasing flow of the dielectric liquid to the battery in response to a temperature of the battery.
